(19) United States
(12) Patent Application Publication
(10) Pub. No.: US 2020/0194946 A1
(43) Pub. Date: Jun. 18, 2020

(54) PROTECTIVE CAP FOR AN RJ45 CONNECTOR

(71) Applicant: Joheves Leamas GARCIA BEARD, Puerto Plata (DO)

(72) Inventor: Joheves Leamas GARCIA BEARD, Puerto Plata (DO)

(21) Appl. No.: 16/468,141

(22) PCT Filed: Dec. 8, 2017
(86) PCT No.: PCT/DO2017/000008

§ 371 Date: Jun. 10, 2019

(30) Foreign Application Priority Data
Dec. 12, 2016 (DO) P12016-0324

(51) Int. Cl. H01R 24/64; H01R 13/506; H01R 13/639

(52) U.S. Cl. CPC H01R 24/64; H01R 13/639; H01R 13/506

(57) ABSTRACT

A protective casing for an RJ45 connector, a device designed to improve the protection against mechanical impacts, electrical contact and chemical reactions in the entire structure of a standard RJ45 connector previously installed on a cable. We present herein two drawings to facilitate the interpretation of the explanations, and 4 claims, wherein we detail the fundamental aspects of the invention where protection of the patent applied for is required.

### TECHNOLOGICAL SECTOR

The present invention provides protection against undesired electrical contact with, and mechanical or chemical damage to, RJ45 network connectors. This may be used in the field of computer networks (Ethernet), computers and communication networks, among others. Said device improves the protection against impacts, against electrical contacts and against environmental agents for an RJ45 connector installed previously on a network cable. Thanks to the characteristics thereof, it may be ideal for industrial communication networks and critical applications which require a high level of reliability.

### KNOWN PRIOR ART

Related solutions are known in the state of the art; see below:
1. Protective rubber sleeve for RJ45 connector
   https://mocubo.es/p/12160-cubierta-de-goma-para-conector-rj45-azul-pack-100-unidades.html
2. Cover for RJ45 connector
   http://www.computercableinc.com/ccinc/products.jsp?sub=RJ45+Cable+Boots&id=4670
3. Application JP2010161049, published on Jul. 22, 2010: To provide a protective cover for a modular RJ45 plug, which may prevent distortion or scratches on an RJ45 modular connector during the transport of a cable with the LAN RJ45 modular connector removed for said transport, and which cannot be lost. SOLUTION: The protective cover 1 for the RJ45 modular connector is connected to the extremity of the LAN RJ45 modular connector. The cover may be released easily by pressing downwards on a locking claw 11 at the extremity of the LAN RJ45 modular connector. Although the cover 1 may be lost, as it is not used when the cable 12 with the LAN RJ45 modular connector is connected to a device or similar, this loss may be avoided by fixing a cable tie 5 to the cable 12 in a cow hitch, in order to integrate the cover 1 and the cable 12; COPYRIGHT: © 2010, JPO & INPIT

The solutions of the state of the art differ from the invention proposed in that the devices only provide minimal mechanical protection to the rearward part of the RJ45 connector, partially protecting the click coupling thereof. Neither can this solution be employed for RJ45 connectors which have already been installed on the cable. Furthermore, the devices are designed to protect the electrical terminals of the RJ45 connector. However, it does not afford any protection against impacts to the rest of the connector.

### DESCRIPTION OF THE INVENTION

The object of the present invention is to improve the mechanical and electrical protection for the RJ45 connectors used in data technology or communications networks.

The need is derived from the vulnerability of these connectors when, in a two-headed cable, one or both heads are not connected to a communications system (dangling, or in contact with the floor or walls), endangering the security of the communications system or the integrity of the connector for its subsequent use.

The invention consists of a cylinder or shell which acts as a protective casing for practically the entire surface of a standard RJ45 connector; it likewise features a push-button which releases the connector when it has been inserted into the same. A hook located at the opposite end of the shell to the inlet port for the RJ45 connector is used to attach the casing to a cable or any other suitable structure.

### DETAILED DESCRIPTION OF THE INVENTION

The casing in question is intended for the protection against impacts and electrical contact of an RJ45 connector (13), as this moves into the inlet port (14) and enters the adjustment cavity (9), the RJ45 connector is secured by the coupling system (11), and the entirety of the vulnerable part of the RJ45 connector remains within the casing. On pressing the uncoupling push-button (3), the uncoupling pin (10) presses the click coupling of the connector, enabling the extraction of the same.

### Improved Mechanical and Chemical Protection (Protection Against Impacts and the Environment).

Due to its shape and structure, this device increases the protection of the entire sensitive surface of the RJ45 connector against mechanical impacts, in some cases including part of the cable installed in the connector. The roundness and shape of the shell (1) afford additional mechanical protection by distributing proportionally any pressure applied to the body of the structure. This cylindrical shape also reduces the possibility of the crushing of the entire unit, as it makes it slippery when subjected to pressure from other surfaces.

Due to the coverage of the RJ45 connector by the invention, the connector and its electrical terminals are afforded better protection against environmental agents which might react chemically with parts of the connector; oxides, dust, damp, etc.

### Improved Electrical Protection (Protection of the Electrical Terminals of the RJ45 Connector).

Thanks to the cavity in the casing, which adjusts to the RJ45 connector (9), the 8 electrical terminals of the RJ45 connector are covered and protected against contact with electrically conductive materials such as oxide, iron filings or even other nearby cabling which might contain electric potential, or short-circuit the terminals of the RJ45 connector.

### Coupling and Uncoupling System For the RJ45 Connector.

By using the same intrinsic coupling system of the RJ45 connector (click coupling), the invention makes use of this property of the connector to latch the same within the casing (11), in such a way that unlike other related inventions, the invention considerably reduces the possibility that the connector might be accidentally removed from the casing, or as a result of the environment where it is located (vibration, temperature, etc.). The uncoupling system for the RJ45 connector features a push-button which, on being pressed by a person's finger, releases the connector from the casing and enables its removal from the same. The push-button is part of the shell, and is designed in such a way that the casing maintains the aforementioned protection of the RJ45 connector.

### Hook For Attachment to Cables or Structure.

The invention features a hook (5) (12) especially designed for its attachment to the cable bearing the RJ45 connector or to any other structure enabling the entry of the hook. This feature facilitates the organisation of the cabling and reduces the exposure of the RJ45 connector to electrical or mechanical damage.

### Holes For Attachment to Various Structures.

The invention features 4 holes (6) located on its sides, designed for the passage of any type of cord, cable tie, or object for the purpose of the additional attachment of the casing to any other structure such as cables, flat surfaces, etc., or to attach to the casing small objects of interest such as labels or tags.

Flat Surfaces For Marking and/or Labelling.

In order that the invention may be labelled or marked by the user, it features 3 flat surfaces (7) distributed around the external part of the casing. Said surfaces may be used for the direct writing thereon using quick-drying ink, or even for the engraving of the brand, label, logo or name of the product.

### Groove For the Affixing of a Sheath.

The groove for the affixing of a sheath (4) provides the user with additional protection for applications where the RJ45 connector may be in direct contact with liquids or in extreme environments. The groove facilitates the affixing to another existing protection (sheath or cover) in order to enhance the protection afforded by the invention, or even as another option for attaching the same to a structure.

### BRIEF DESCRIPTION OF THE DRAWINGS

FIG. 1 portrays a complete general three-dimensional view of the invention, wherein the principal parts and functions of the same may be seen.

Description of the parts:
1. Hollow protective shell.
2. RJ45 connector inlet port.
3. Push-button for the uncoupling of the RJ45 connector.
4. Groove for the affixing of a sheath.
5. Hook for attachment to cables or structure.
6. Holes for attachment to various structures.
7. Flat surface for marking or engraving.

FIG. 2 portrays a lateral view, including an RJ45 connector of the industrial type. In this figure, the internal parts of the invention may be seen: the coupling and uncoupling system for the RJ45 connector.

Description of the parts:
8. Hollow protective shell.
9. Adjustment and protective cavity for the RJ45 connector.
10. Uncoupling pin for the RJ45 connector.
11. Coupling system for the RJ45 connector.
12. Hook for attachment to cables or structure.
13. RJ45 connector, industrial type (Not included in the invention).
14. RJ45 connector inlet port.

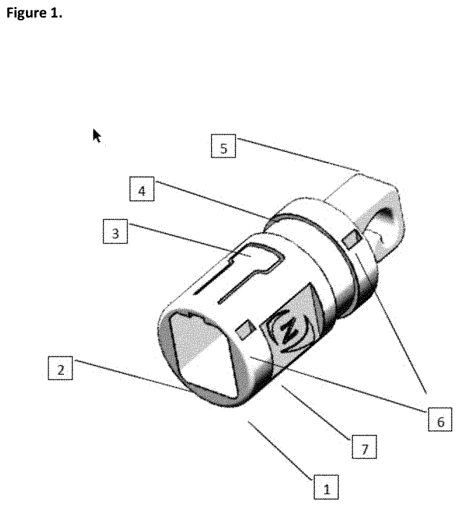

FIG. 1 portrays a PROTECTIVE CASING FOR AN RJ45 CONNECTOR featuring a hollow protective shell (1) able to house completely the body of a standard RJ45 connector, and in some cases, part of the cable attached to the same. The hollow part of the shell enables the RJ45 connector to be guided toward the adjustment cavity (9), where it remains locked until the user decides to remove it, using the uncoupling push-button (3) which also forms part of the shell. The shell features 4 holes (6) for the attachment of the entire unit to a cable or structure, and 3 flat surfaces located on its exterior for the writing with ink or the engraving of letters, inscriptions or logos.

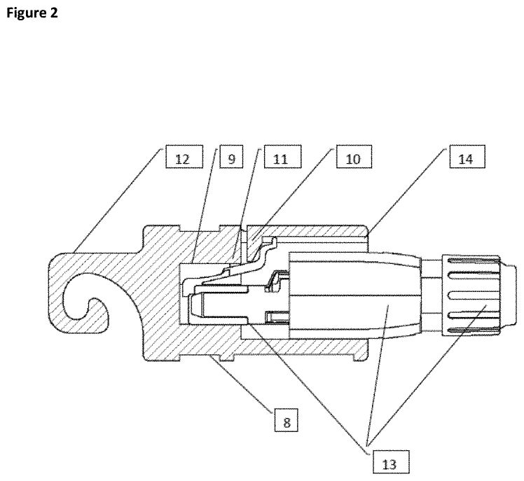

FIG. 2 portrays the uncoupling push-button (3); this is a mechanical push-button which enables the release of the RJ45 connector after being inserted into the protective shell and the adjustment cavity. When a person presses this push-button with his/her finger, it comes into contact with the click coupling of the RJ45 connector, releasing it from the adjustment cavity (9) and subsequently enabling the withdrawal of the connector from the casing, where the hook featuring a spiral-shaped space (12) enables the attachment of the casing to cables by means of the progressive pressing of the same, due to a reduction in diameter from the initial entry diameter to the final diameter. When a cable is located in the hook, it may be moved gradually to the point where the desired pressure and grip is obtained.

Where the hook featuring a spiral-shaped space (12) is used for the purpose of hanging the casing together with the RJ45 connector therein, to enable easy availability and the organisation of the assembly.

1. A PROTECTIVE CASING FOR AN RJ45 CONNECTOR, characterised in that it features a hollow protective shell (1) able to house completely the body of a standard RJ45 connector, and in some cases, part of the cable attached to the same. The hollow part of the shell enables the RJ45 connector to be guided toward the adjustment cavity (9), where it remains locked until the user decides to remove it, using the uncoupling push-button (3) which also forms part of the shell. The shell features 4 holes (6) for the attachment of the entire unit to a cable or structure, and 3 flat surfaces located on its exterior for the writing with ink or the engraving of letters, inscriptions or logos.

2. A PROTECTIVE CASING FOR AN RJ45 CONNECTOR, as claimed in claim 1, characterised in that the uncoupling push-button (3) features a mechanical push-button which enables the release of the RJ45 connector after being inserted into the protective shell and the adjustment cavity. When a person presses this push-button with his/her finger, it comes into contact with the click coupling of the RJ45 connector, releasing it from the adjustment cavity (9) and subsequently enabling the withdrawal of the connector from the casing.

3. A PROTECTIVE CASING FOR AN RJ45 CONNECTOR, as claimed in claim 1, characterised in that the hook with a spiral-shaped space (12) enables the attachment of the casing to cables by means of the progressive pressing of the same, due to a reduction in diameter from the initial entry diameter to the final diameter. When a cable is located in the hook, it may be moved gradually to the point where the desired pressure and grip is obtained.

4. A PROTECTIVE CASING FOR AN RJ45 CONNECTOR, as claimed in claim 3, characterised in that the hook with a spiral-shaped space (12) is used for the purpose of hanging the casing together with the RJ45 connector therein, to enable easy availability and the organisation of the assembly.
